(19) United States
(12) Patent Application Publication
(10) Pub. No.: US 2007/0052869 A1
(43) Pub. Date: Mar. 8, 2007

(54) Long-distance digital visual interface (DVI) apparatus

(75) Inventor: Edward J. Priest, Alameda, CA (US)

Correspondence Address: DLA PIPER RUDNICK GRAY CARY US, LLP, 2000 UNIVERSITY AVENUE, E. PALO ALTO, CA, 94303-2248, US

(73) Assignee: Black Diamond Video, Inc.

(21) Appl. No.: 11/218,453

(22) Filed: Sep. 2, 2005

(51) Int. Cl. H04N 9/65

(52) U.S. Cl. 348/735; 348/661; 348/642

(57) ABSTRACT

A cost-effective apparatus and method for equalizing signals (e.g., TMDS signals) is presented. The apparatus includes a housing and an input connector and an output connector on the housing. An equalizer chip inside the housing receives input pixel signals from the input connector and transmits output pixel signals through the output connector. An buffer (e.g., an I²C buffer), which is also located inside the housing, receives input control signals (e.g., input I²C signals) from the input connector and transmits output control signals (e.g., output I²C signals) to the output connector. The apparatus may be operated in single-link or dual-link mode. A copper cable connecting a DVI signal source to the input connector may be as long as 60 meters without causing noticeable signal deterioration.

### FIELD OF INVENTION

The invention relates generally to a Digital Visual Interface (DVI) apparatus and particularly to transmission of DVI signals over long distance.

### BACKGROUND

Since the development of Digital Visual Interface (DVI) by the Digital Display Working Group (DDWG), DVI has become a digital interface standard for converting analog signals to digital signals to accommodate both digital and analog display devices. DVI signals are transmitted by a Transition Minimized Differential Signaling (TMDS) protocol, providing a digital signal from a video source to a display device.

DVI interface provides numerous advantages. For example, where the display device is an analog device, the image quality deterioration that would result from converting the digital signals to analog signals can be avoided by digitally transmitting the signals between the graphics subsystem and the display device. Also, the DVI standard specifies a single plug-and-connector that encompasses VGA (analog) interfaces as well as digital-only plug connector, making the interface versatile. Furthermore, DVI can handle bandwidth in excess of 165 MHz, and thus supports UXGA and HDTV signal rates in a single link mode.

In spite of the numerous advantages DVI provides, DVI's use has been limited by the fact that its signals cannot travel long distances over copper cable without compromising the image quality. Typically, a conventional copper cable connected to the video source will carry the signals only up to about 10 meters. For many corporations and larger residences, a separation distance between the video source and the monitor needs to be more than 10 meters to be conveniently useful. Thus, a method and device that allows a high-resolution, high-quality transmission of DVI video signals over distances greater than 10 meters is desired.

### SUMMARY

In one aspect, the invention is an apparatus for equalizing signals (e.g., TMDS signals). The apparatus includes a housing and an input connector and an output connector on the housing. An equalizer chip inside the housing receives input pixel signals from the input connector and transmits output pixel signals through the output connector. A buffer, which is also located inside the housing, receives input control signals from the input connector and transmits output control signals to the output connector.

In another aspect, the invention is a method of equalizing signals (e.g., TMDS signals). The method entails receiving a set of input pixel signals and a control signal from an input connector. Each of the input pixel signals are passed through a respective one of a set of adaptive equalizers, then through a respective one of a set of limiting amplifiers. The output from each of the set of limiting amplifiers is forwarded to an output connector. As for the control signal, it is passed through a buffer and then forwarded to the output connector.

In yet another aspect, the invention is an apparatus for equalizing TMDS signals. The apparatus includes a housing and an input connector and an output connector on the housing. A first equalizer chip is located in the housing to receive a first subset of the input pixel signals and the input clock signal from the input connector, generate a first subset of output pixel signals, transmit the first subset of output pixel signals to the output connector, and forward the input clock signal to a second equalizer chip. The second equalizer chip, which is also located in the housing, receives a second subset of the input pixel signals from the input connector and the input clock signal from the first equalizer chip, generates a second subset of output pixel signals, and transmits the second subset of output pixel signals to the output connector. An I²C buffer in the housing receives input I²C signals from the input connector and transmits output I²C signals to the output connector. The input pixel signals, the first subset of output pixel signals, and the second subset of output pixel signals are TMDS signals.

### BRIEF DESCRIPTION OF THE DRAWINGS

FIG. 1 is a diagram of a TMDS equalizer apparatus in accordance with the invention.

FIG. 2 is a diagram of the TMDS equalizer apparatus illustrating details of the equalizer box and the first and the second cables.

FIGS. 3A and 3B are illustrations of input and output connectors on the equalizer box.

FIG. 4 is an exemplary embodiment of an equalizer chip that may be used in the TMDS equalizer apparatus.

FIG. 5 is an exemplary embodiment of an I²C buffer that may be used in the TMDS equalizer apparatus.

FIG. 6 is an illustration of multiple equalizer boxes in a daisy-chain configuration.

### DETAILED DESCRIPTION OF THE EMBODIMENT(S)

Embodiments of the invention are described herein in the context of DVI. However, it is to be understood that the embodiments provided herein are just exemplary embodiments, and the scope of the invention is not limited to the applications or the embodiments disclosed herein.

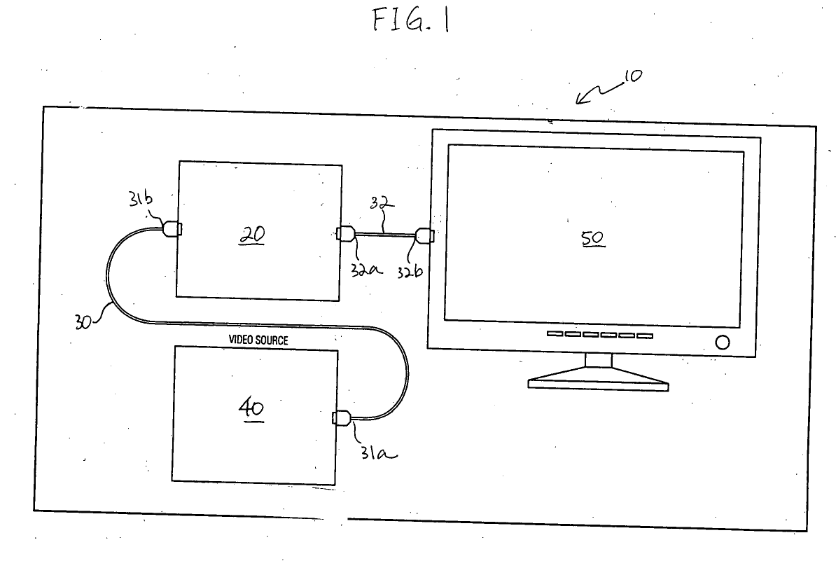

FIG. 1 is a general diagram of a TMDS equalizer apparatus 10 in accordance with the invention. As shown, the TMDS equalizer apparatus 10 includes an equalizer box 20, a first cable 30 that connects the equalizer box 20 to a video source 40, and a second cable 32 that connects the equalizer box 20 to a display device 50. The first cable 30 has a first end 31a and a second end 31b, wherein the first end 31a is connected to the video source 40 and the second end 31b is connected to an input end of the equalizer box 20. The second cable 32 has a third end 32a and a fourth end 32b, wherein the third end 32a is connected to the output end of the equalizer box 20 and the fourth end 32b is connected to the display device 50.

DVI signals from the video source 40 travel through the equalizer box 20 to reach the display device 50. Without the equalizer box 20, the DVI signals experience significant deterioration when the travel distance between the video source 40 and the display device 50 is greater than about 10 meters. The signal deterioration adversely affects the quality of the image displayed on the display device 50. However, with the addition of the equalizer box 20, this deterioration is avoided even for a signal travel distance of up to 60 meters.

The video source 40 may be any known video signal source including but not limited to graphic cards, digital broadcast, digital cable, digital satellite, a DVD, or a Blu-Ray Disc.

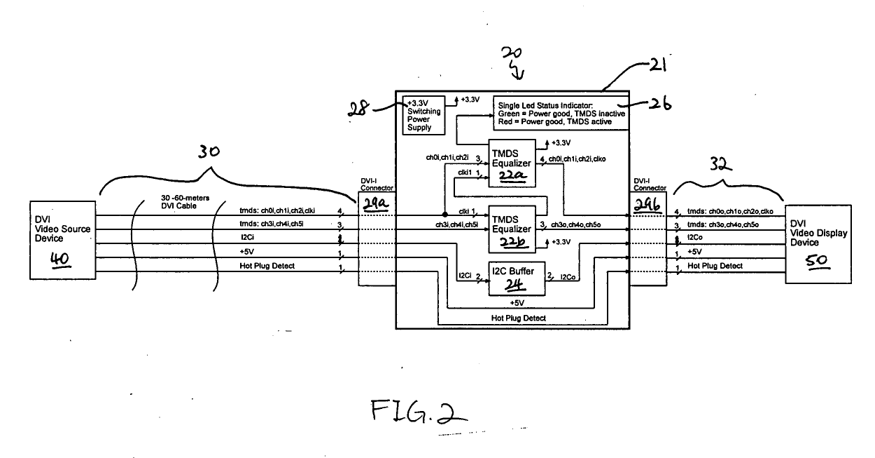

FIG. 2 is a diagram of the TMDS equalizer apparatus 20 illustrating details of the equalizer box 20 and the first and the second cables 30, 32.

Signals from the video source 40 are fed to the equalizer box 20 through an input connector 29a. The first four channels in the first cable 30 (shown as ch0ᵢ, ch1₁, ch2ᵢ, clkᵢ) carry three input pixel signals (e.g., red, green, blue) and a clock signal. Each channel consists of a shielded twisted pair (STP) of wires. The second three channels (shown as ch3ᵢ, ch4ᵢ, ch5ᵢ) are used to carry another set of input pixel signals when the equalizer box 20 is operating in a dual-link mode. There is one pre-conditioned DVI DDC I²C communication channel, one pass through DVI+5V channel, and a hot plug detection signal channel between the video source 40 and the equalizer box 20.

The equalizer box 20 includes equalizer chips 22a, 22b and an I²C buffer 24 placed inside a housing 21. In an exemplary embodiment, each of the equalizer chips 22a, 22b is implemented with a Maxim semiconductor MAX3815 TMDS equalizer chip. The equalizer chips preferably operate at a wide temperature range, such as at least between zero and 70° C. The input pixel signals in ch0ᵢ, ch1ᵢ, ch2ᵢ, and clkᵢ are fed to the equalizer chip 22a, which processes them and generates three output pixel signals ch0ₒ, ch1ₒ, ch2ₒ, and an output clock signal clkₒ. These four output signals are then carried to the display device 50 by four STP channels in the second cable 32, which is connected to the equalizer box 20 through an output connector 29b. In the single link mode, the input clock signal clkᵢ is fed directly to the equalizer chip 22a.

If the equalizer box 20 is operating in the dual-link mode, the input pixel signals ch3ᵢ, ch4ᵢ, and ch5ᵢ are fed to the equalizer chip 22b for separate processing. Currently, the maximum bandwidth achievable with a single link is about 165 MHz, and dual-link mode operation is used if a bandwidth greater than 165 MHz is desired. In the dual-link mode, alternate pixels are transmitted on each link so that one link (e.g., ch0ᵢ, ch1ᵢ, ch2ᵢ) transmits the odd pixels of a frame and the other link (ch0ₒ, ch1ₒ, ch2ₒ) transmits the even pixels from the same output. In the dual-link mode, the input clock signal clkᵢ is split and fed to the equalizer chip 22b and also to the equalizer chip 22a from the equalizer chip 22b. The equalizer chip 22b processes the input pixel signals and generates output pixel signals ch3ₒ, ch4ₒ, ch5ₒ.

Since the equalizer chip 22b is used only in dual-link mode operation, it may be omitted where the equalizer box 20 is intended to operate only in the single-link mode.

The I²C buffer 24 reconditions the I²C data communication channels, thereby conditioning the communication between the video source 40 and the display device 50 for distances up to 60 meters. The I²C buffer 24 receives the input signals I²Cᵢ and generates the output signals I²Cₒ. In one embodiment, the I²C buffer 24 is implemented with the LTC4300A-2 Hot Swappable 2-wire Bus Buffers commercially made available by Linear Technology Corporation.

A +3.3V switching power supply 28 powers the equalizer chips 22a, 22b as shown, while reducing overall power consumption.

The equalizer box 20 may optionally also include a power status indicator, such as an LED 26. The LED 26 may be located on an outer surface of the housing 21, thus providing visual indication to a user of the equalizer box 20. In an exemplary embodiment, the LED 26 is green when the equalizer box 20 is turned on and no signals are detected, and red when signals are detected. The LED 26 offers a quick debugging aid for the end user regarding TMDS signal activity and power status. The LED 26 is connected to the equalizer chip 22a so that proper indicator light may be turned on in response to the power and signal status. If desired, the power status indicator may be implemented with components other than the LED 26.

The first cable 30 may be a copper cable that is as long as the separation distance between the video source 40 and the equalizer box 20 (e.g., 60 meters). The second cable 32 may be a regular DVI cable up to 5 meters in length.

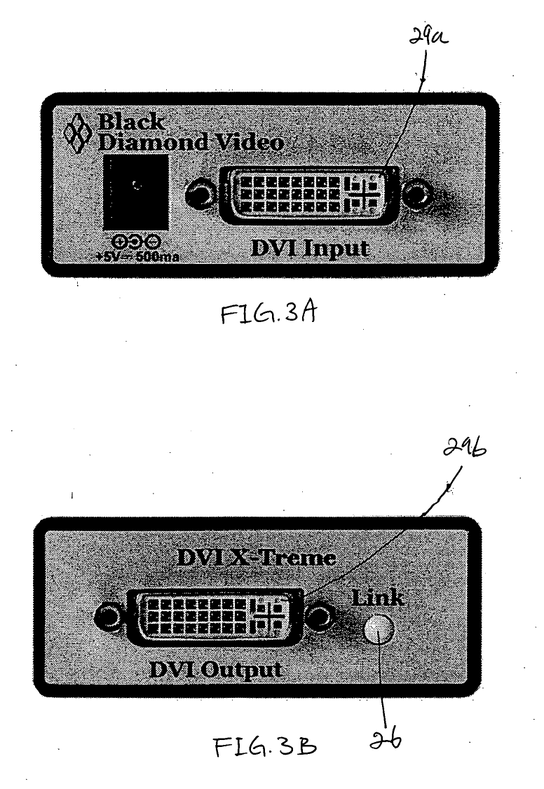

FIGS. 3A and 3B are illustrations of the input connector 29a and the output connector 29b on the equalizer box 20, respectively. The same connector may be used for both the input connector 29a and the output connector 29b. As shown in FIG. 2, there are two connectors 29a, 29b on the equalizer box 20, each of which is designed to handle either single-link or dual-link transmission. The equalizer box 20 receives signals through the connector 29a and outputs signals through the connector 29b. The connectors 29a, 29b incorporate pins that pass through analog signals according to the DVI standard. Thus, the connectors 29a, 29b can be used with either analog or digital display devices.

The TMDS equalizer apparatus 10 provides a simple and cost-effective alternative to expensive fiber optic solutions or multiple daisy-chained repeaters/reclockers.

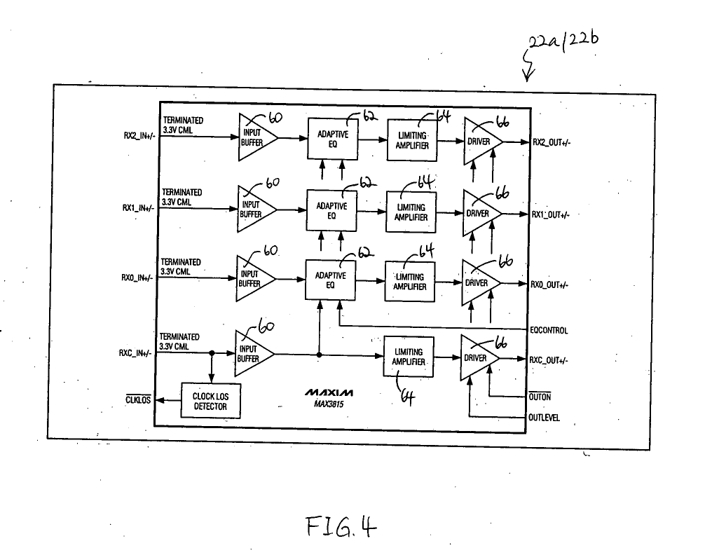

FIG. 4 is an exemplary embodiment of an equalizer chip 22a/22b (Maxim's MAX3815) that may be used in the TMDS equalizer apparatus. As shown, each input signal that enters the equalizer box 20 is individually received by an input buffer 60 before being forwarded to an adaptive equalizer 62. Each adaptive equalizer 62 analyzes the incoming signal and determines the amount of equalization to apply. Then, the output of each adaptive equalizer 62 is fed to each of a set of limiting amplifiers 64 before reaching the output connector 29b through separate output drivers 66. Each of the limiting amplifiers 64 amplifies the signal from the adaptive equalizer and truncates the top and bottom of the waveform to provide a clean high- and low-level signal to the output drivers 66. There is a loss-of-clock signal detector 68 that detects a loss of clock signal at the clock input pin.

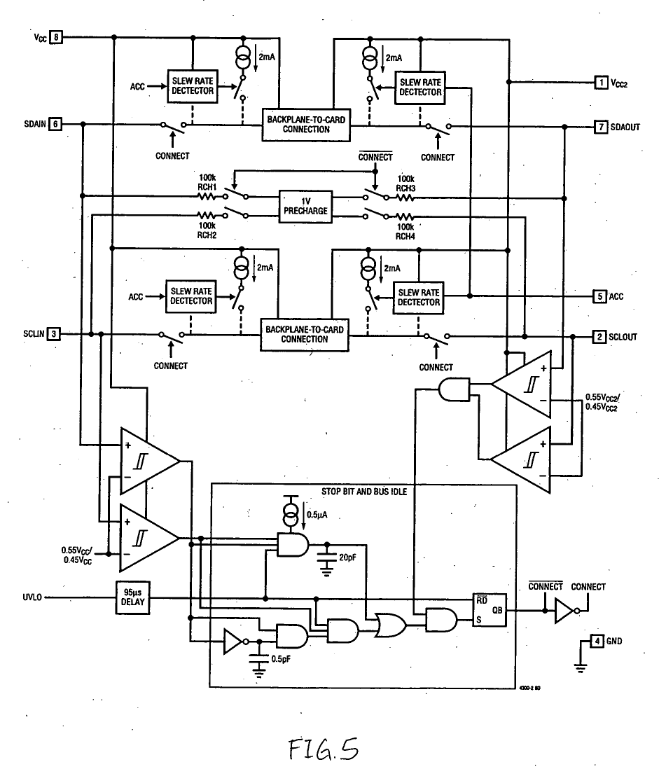

FIG. 5 is an exemplary embodiment of an I²C buffer (Linear Technology Corporation's LTC4300A-2) that may be used in the TMDS equalizer apparatus. The I²C buffer 24 conditions the I²C data by providing more drive strength to counter the loss caused by the copper cable. The I²C buffer 24 provides the communication channel between the video source 40 and the display device 50, and the video source 40 does not drive the TMDS data unless it can properly communicate with the display device 50 over the I²C bus. The I²C buffer provides a reliable communication link between the video source 40 and the display device 50 over the I²C bus.

If the equalizer chips 22a/22b were used without the I²C buffer 24, the communication range between the video source 40 and the display device 50 would be significantly shortened. Without the I²C buffer 24 to condition the I²C signals, it is likely that the communication channel between the video source 24 and the display device 50 will be deteriorated to the point of failure. If no communication is established, the video source 40 does not transmit the TMDS signals. Establishment of good communication between the video source 40 and the display device 50 may be desirable where the video source 40 uses HDCP encryption, in which case the source continuously communicates with the display device over the I²C bus.

The long-distance DVI apparatus of the invention expands the realm of possible applications of DVI to uses where the display device can be more than 10 meters away from the video source. Some of these applications include command and control centers, educational institutions, clinical interfaces and entertainment. The apparatus may be used for digital signage, tradeshow and event production and management, IT control centers, commercial studios, editorial and production houses, and home theater/smart home installations, among others.

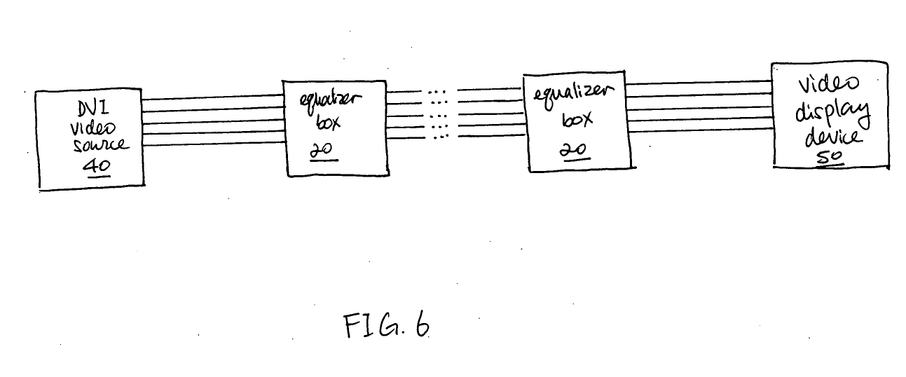

Although there is still a limit to the distance over which a single equalizer box 20 can transmit high-resolution video signals, this limit can be stretched by daisy-chaining multiple equalizer boxes, as shown in FIG. 6. For example, by connecting the video source 40 to a first equalizer box 20 with a first 50-meter copper cable, and connecting the output of the first equalizer box 20 to a second equalizer box 20 with a second 50-meter copper cable before finally connecting the second equalizer box 20 to the video display device 50, high-resolution signal transmission can be achieved for over 100 meters total distance. The number of equalizer boxes one would want to daisy-chain depends on the desired signal quality at the video display device 50.

While the foregoing has been with reference to particular embodiments of the invention, it will be appreciated by those skilled in the art that changes in this embodiment may be made without departing from the principles and spirit of the invention. For example, the invention is not limited to a particular way of laying out the equalizer chips 22a, 22b and the I²C buffer 24 on a printed circuit board, and any layout that is considered suitable by a person of ordinary skill in the art is contemplated.

What is claimed is:

1. An apparatus for equalizing signals, the apparatus comprising:
a housing;
an input connector and an output connector on the housing;
an equalizer chip inside the housing, the equalizer chip receiving input pixel signals from the input connector and transmitting output pixel signals through the output connector; and
a buffer inside the housing, the buffer receiving input control signals from the input connector and transmitting output control signals to the output connector.

2. The apparatus of claim 1, wherein the control signals are I²C signals and the buffer is an I²C buffer.

3. The apparatus of claim 1 further comprising a visual indicator indicating whether input signals are being received.

4. The apparatus of claim 3, wherein the visual indicator is a light emitting diode that emits different colored light depending on whether input signals are being received.

5. The apparatus of claim 1 further comprising:
a first cable having a first end and a second end wherein the first end is coupled to a video signal source and the second end is coupled to the input connector; and
a second cable having a third end and a fourth end wherein the third end is coupled to the output connector and the fourth end is coupled to a display device.

6. The apparatus of claim 5, wherein the first cable is more than 30 meters long.

7. The apparatus of claim 5, wherein the first cable is a copper cable.

8. The apparatus of claim 1, wherein the input pixel signals and the output pixel signals are TMDS signals.

9. The apparatus of claim 1, wherein the equalizer chip receives a clock signal from the input connector along with the input pixel signals.

10. The apparatus of claim 9, wherein the equalizer chip is a first equalizer chip, further comprising a second equalizer chip that directly receives the clock signal from the input connector and forwards the clock signal to the first equalizer chip.

11. The apparatus of claim 10, wherein the input pixel signals and the output pixel signals are first set of input pixel signals and a first set of output pixel signals, and wherein the second equalizer chip receives a second set of input pixel signals and transmits a second set of output pixel signals to the output connector.

12. The apparatus of claim 11, wherein the first set of input pixel signals include odd pixels of a frame and the second set of input pixel signals include even pixels of the frame.

13. The apparatus of claim 1, wherein the input connector and the output connector are DVI-I connectors capable of operating in either single-link mode or dual-link mode.

14. A method of equalizing signals, the method comprising:
receiving a set of input pixel signals from an input connector;
passing each of the set of input pixel signals through each of a set of adaptive equalizers;
passing an output from each of the set of adaptive equalizers through each of a set of limiting amplifiers;
passing an output from each of the set of limiting amplifiers to an output connector;
receiving a control signal from the input connector; and
passing the control signal through a buffer and forwarding an output of the buffer to the output connector.

15. The method of claim 14, wherein the control signal is an I²C signal and the buffer is an I²C buffer.

16. The method of claim 14 further comprising passing each of the set of input pixel signals through a separate input buffer before passing an output from the separate input buffer through the set of adaptive equalizers.

17. The method of claim 14 further comprising passing the output from each of the set of limiting amplifiers through a separate output driver to produce output pixel signals before transmitting the output pixel signals to the output connector.

18. The method of claim 14 further comprising receiving an input clock signal from the input connector.

19. The method of claim 18, wherein the input pixel signals are a first set of input pixel signals, the set of adaptive equalizers is a first set of adaptive equalizers, and the set of limiting amplifiers is a first set of limiting amplifiers, further comprising:
receiving a second set of input pixel signals from the input connector;
passing each of the second set of input pixel signals through a second set of adaptive equalizers;
passing an output from each of the second set of adaptive equalizers through each of a second set of limiting amplifiers;
passing an output from each of the second set of limiting amplifiers through an output driver to the output connector; and
passing the input clock signal through the second set of adaptive equalizers before passing the input clock signal through the first set of adaptive equalizers.

20. The method of claim 14, wherein the set of input pixel signals are generated at a video source and travel through at least 30 meters of cable before reaching the input connector.

21. The method of claim 20, wherein the cable is a copper cable.

22. The method of claim 14, wherein the input pixel signals are TMDS signals.

23. An apparatus for equalizing signals, the apparatus comprising:
a housing;
an input connector and an output connector on the housing;
a first equalizer chip in the housing, the first equalizer chip receiving a first subset of the input pixel signals and the input clock signal from the input connector, generating a first subset of output pixel signals, transmitting the first subset of output pixel signals to the output connector, and forwarding the input clock signal to a second equalizer chip;
a second equalizer chip in the housing, the second equalizer chip receiving a second subset of the input pixel signals from the input connector and the input clock signal from the first equalizer chip, generating a second subset of output pixel signals, and transmitting the second subset of output pixel signals to the output connector; and
an I²C buffer receiving input I²C signals from the input connector and transmitting output I²C signals to the output connector;
wherein the input pixel signals, the first subset of output pixel signals, and the second subset of output pixel signals are TMDS signals.

24. The apparatus of claim 23 further comprising:
a first cable connected to the input connector for providing input pixel signals and an input clock signal to the input connector; and
a second cable connected to the output connector for transmitting output pixel signals and an output clock signal to a display device.

25. The apparatus of claim 24, wherein one of the first cable and the second cable is at least 30 meters long.
